(19) United States
(12) Patent Application Publication
(10) Pub. No.: US 2022/0209635 A1
(43) Pub. Date: Jun. 30, 2022

(54) VIBRATING MOTOR

(71) Applicant: AAC Microtech (Changzhou) Co., Ltd., Changzhou City (CN)

(72) Inventors: Yan Shao, Shenzhen (CN); Xiaorong Zhou, Shenzhen (CN); Fanghua Ling, Shenzhen (CN); Zixu Hua, Shenzhen (CN)

(21) Appl. No.: 17/543,663

(22) Filed: Dec. 6, 2021

(30) Foreign Application Priority Data
Dec. 25, 2020 (CN) 202023204614.1

(51) Int. Cl. H02K 33/02

(52) U.S. Cl. CPC H02K 33/02

(57) ABSTRACT

A vibrating motor is provided in the present disclosure. The vibrating motor includes a housing providing an accommodating space, a vibrator and a stator received in the accommodating space, and an elastic member suspending the vibrator elastically in the accommodating space; the elastic member includes an elastic arm, a first fastening portion and a second fastening portion bending and extending towards a same side of the elastic arm from both ends of the elastic arm respectively, the first fastening portion is fixed on the vibrator while the second fastening portion is fixed on the housing, the vibrator is sandwiched between the first and second fastening portion.

### FIELD OF THE DISCLOSURE

The present disclosure generally relates to vibrating motor, and more particularly, to a vibrating motor for providing vibration feedback.

### BACKGROUND

A typical vibrating motor includes a shell and a vibrating module received in the shell while an elastic member suspending the vibrating module. The elastic member of a related vibrating motor is configured to be a straight plate which located at both sides of the vibrating module, as two ends of the straight plate has to fixed on the vibrating module and the shell respectively to suspend the vibrating module, the force arm length is compressed, and the force moment of the elastic member is too short to maintain a low stress and causing the elastic member fracture. Further, the assembly procedure of the elastic member is complicated since the elastic member has to soldering to two separate parts of the shell.

Therefore, it is desired to provide a vibrating motor to overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic perspective view of a vibrating motor according to the present disclosure;

FIG. 2 is a cross-sectional view taken along line A-A of the linear vibration motor shown in FIG. 1;

FIG. 3 is a cross-sectional view taken along line B-B of the linear vibration motor shown in FIG. 1;

FIG. 4 is a schematic perspective view of the vibrating motor in FIG. 1 with a cover thereof removed;

FIG. 5 is an exploded view of a vibrating motor shown in FIG. 1.

### DETAILED DESCRIPTION

The present disclosure will be described in detail below with reference to the attached drawings and embodiment thereof.

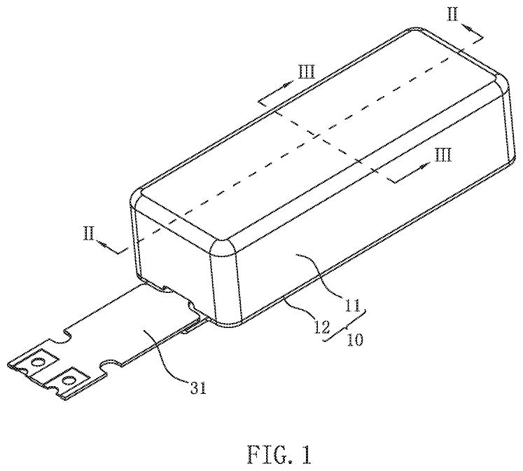

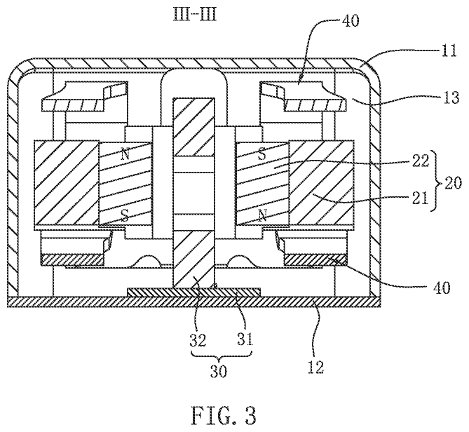

Referring to FIGS. 1-5, a vibrating motor 100 according to an exemplary embodiment of the present disclosure is shown. The vibrating motor 100 includes a housing 10 providing an accommodating space 13, a vibrator 20, a stator 30 received in the accommodating space 13, and an elastic member 40 suspending the vibrator 20 elastically in the accommodating space 13.

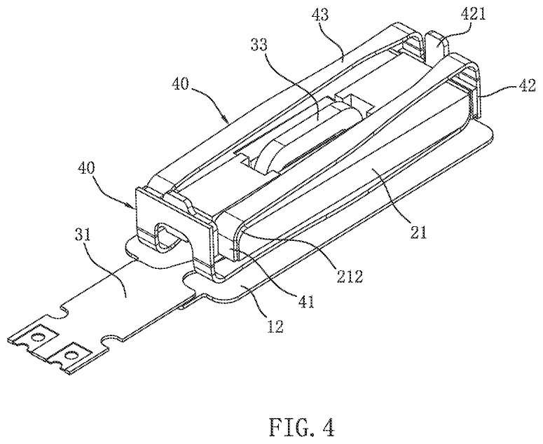

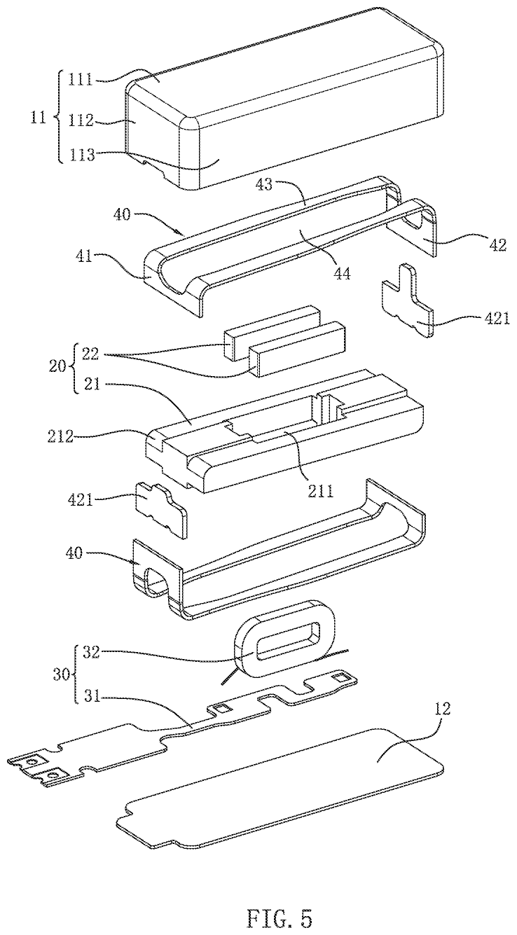

As illustrated in FIG. 4-5, the housing is configured to be a cuboid in shape, including a cover 11 having an opening and a base 12 sealing the opening of the cover 11, the cover 11 and the base 12 defines the accommodating space 13, the vibrator 20 is fixed on the cover 11. Specifically, the cover 11 includes an upper wall 111 opposite to the base 12 and a plurality of sidewalls bending and extending from the upper wall 111, the vibrator is configured to be a rectangular frame structure, the plurality of sidewalls includes a first sidewall 112 located at both sides of the vibrator 20 along a length direction, and a second sidewall 113 located at both sides of the vibrator 20 along a width direction.

In the present embodiment, the vibrator 20 includes a weight 21 providing a receiving groove 211, and a magnet 22 assembling with the receiving groove 211, the stator 30 includes a circuit board 31 fixing on the base 12 and a coils 32 assembling while electrically connecting with the circuit board 31, the coils 32 received in the receiving groove 211 in part and coupled with the magnet 22. The weight 21 is suspending by the elastic member 40 elastically, while the weigh 21 can be driven to vibrates linearly due to the interaction between the magnet 22 and the coils 32, the elastic member 40 provides elastic recovery force for the vibrator 20 to return to an initial position, and guides vibrate direction. The circuit board 31 is connecting with external power and supplies the coils 32 electrical.

The receiving groove 211 runs through the weight 21, the magnet 22 includes two, two of the magnet 22 is are set symmetrically with respect to the coils 32, and two of the magnet 22 are magnetize opposite along the vibrated direction, so the interaction between the coils 32 and the magnet 22 becomes stronger, and the vibrating motor 100 can achieved a stronger feedback. Furthermore, the coils 32 can received in the receiving groove 211 while the base 12 assemble with the cover 11, the assembly and alignment procedure has been optimized to save the cost of production.

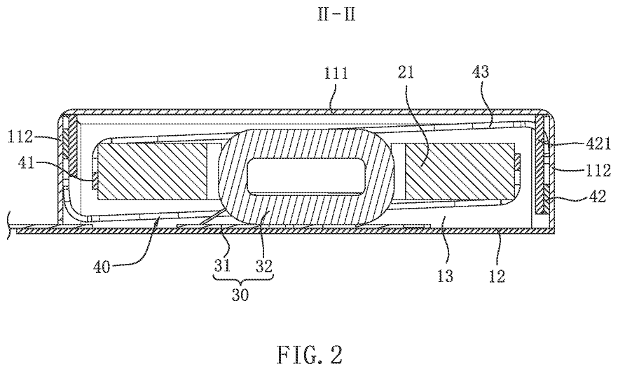

Referring to FIG. 2 and FIG. 4, the elastic member 40 includes two. Two of the elastic member are symmetry with respect to a geometric center of the vibrator 20, and are located on both sides of the vibrator 20 along the vibrate direction.

The elastic member 40 includes an elastic arm 43, a first fastening portion 41 and a second fastening portion 42 bending and extending towards a same side of the elastic arm 43 from both ends of the elastic arm 43 respectively, the first fastening portion 41 is fixed on the vibrator 20 while the second fastening portion 42 is fixed on the cover 11, the vibrator 20 is sandwiched between the first fastening portion 41 and the second fastening portion 42. As the first fastening portion 41 and the second fastening portion 42 are both bending from the elastic arm 43, the length of the elastic arm 43 is being used effectively, and the force moment of the elastic member 40 has been elongated to reduce the stress that the elastic member suffered, which extending the service life of the elastic member 40.

Furthermore, since the elastic member 40 of the present embodiment is only fastened to the cover 11 of the housing 10, it avoid the problem of the typical vibrating motor when soldering the elastic member to two separate parts of the shell, the assembling procedure has been optimized.

The elastic member formed as U-shape in general, and the elastic arm 43 is connecting with the first fastening portion 41 and the second fastening portion 42 in an arc, the vibrator 20 is suspending in the accommodating space 13 through the elastic arm 43.

The first fastening portion 41 soldered on a side of the weight 21 along a length direction, and the second fastening portion 42 soldered on the first sidewall 112 which is away from the side of the weight 21, and two of the elastic member 40 are symmetry with respect to a geometric center of the vibrator 20 for avoiding polarization of vibrator 20.

In order to prevent impacting between the elastic member 40 and the vibrator 20, the elastic arm 43 forming an obtuse angle against the first fastening portion 41 while forming an acute angle against the second fastening portion 43, and the first fastening portion 41 is parallel with the second fastening portion 42. Moreover, the vibrator 20 chamfered corresponding to where the elastic arm 43 and the first fasten portion 41 connecting, so the space for vibrate is enlarged.

In the present embodiment, the elastic member 40 is configured to be an metal plate with an through hole 44, and the through hole 44 extending from the first fastening portion 41 to the second portion 42, the through hole 44 can increase the elastic force of the elastic member 40, and can avoiding the impact between the elastic member and the coils 32.

As illustrated in FIG. 4-5, an fixed plate 421 soldering on a side of the second fastening portion 42 away from the cover 11, and the fixed plate 421 is configured to covered the through hole 44 in part. The fixed plate 421 enhances the binding strength of second fastening portion 42 and the cover 11, and preventing the situation of sealing-off.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vibrating motor, comprising:
a housing providing an accommodating space;
a vibrator and a stator received in the accommodating space;
an elastic member suspending the vibrator elastically in the accommodating space;
wherein the elastic member comprises an elastic arm, a first fastening portion and a second fastening portion bending and extending towards a same side of the elastic arm from both ends of the elastic arm, respectively, the first fastening portion is fixed on the vibrator while the second fastening portion is fixed on the housing, the vibrator is sandwiched between the first and second fastening portion.

2. The vibrating motor as described in claim 1, wherein an amount of the elastic member is two, and two of the elastic member are symmetry with respect to a geometric center of the vibrator.

3. The vibrating motor as described in claim 1, wherein the elastic arm forming an obtuse angle against the first fastening portion while forming an acute angle against the second fastening portion, and the first fastening portion is parallel with the second fastening portion.

4. The vibrating motor as described in claim 1, wherein the elastic arm is connecting with the first fastening portion and the second fastening portion in an arc, and the vibrator chamfered corresponding to where the elastic arm and the first fastening portion connecting.

5. The vibrating motor as described in claim 1, wherein the elastic member is configured to be an metal plate with an through hole, and the through hole extending from the first fastening portion to the second portion.

6. The vibrating motor as described in claim 5, further comprises an fixed plate soldering on a side of the second fastening portion away from the housing, and the fixed plate is configured to covered the through hole in part.

7. The vibrating motor as described in claim 1, wherein the housing comprises a cover and a base cooperating with the cover, the cover and the base defines the accommodating space, and the vibrator is fixed on the cover.

8. The vibrating motor as described in claim 7, wherein the cover defining a upper wall opposite to the base and a plurality of sidewalls bending and extending from the upper wall, the vibrator is configured to be a rectangular frame structure, the plurality of sidewalls comprises a first sidewall located at both sides of the vibrator along a length direction, and a second sidewall located at both sides of the vibrator along a width direction, the first fastening portion soldered on a side of the vibrator, and the second fastening portion soldered on the first sidewall which is away from the side of the vibrator.

9. The vibrating motor as described in claim 7, wherein the vibrator comprises a weight providing a receiving groove, and a magnet assembling with the receiving groove, the stator comprises a circuit board fixing on the base and a coils assembling while electrically connecting with the circuit board, the coils received in the receiving groove in part and coupled with the magnet.

10. The vibrating motor as described in claim 9, wherein an amount of the magnet is two, and two of the magnet are magnetized in an opposite direction.
